(19) United States
(12) Patent Application Publication
(10) Pub. No.: US 2014/0129585 A1
(43) Pub. Date: May 8, 2014

(54) INFORMATION MANAGEMENT SYSTEMS AND METHODS

(71) Applicants: Oliver Furniss, Windsor (AU); Benjamin Lehman, Myrtle Bank (AU); Bernard Blake, Alberfeldie (AU); Nicholas Strybosch, West Footscray (AU); Renato Ulpiano, Ascot Vale (AU); Robert Phillpot, Hawthorn (AU); Leigh Jasper, Menlo Park, CA (US); Justin Mckinlay, Surrey Hills (AU)

(72) Inventors: Oliver Furniss, Windsor (AU); Benjamin Lehman, Myrtle Bank (AU); Bernard Blake, Alberfeldie (AU); Nicholas Strybosch, West Footscray (AU); Renato Ulpiano, Ascot Vale (AU); Robert Phillpot, Hawthorn (AU); Leigh Jasper, Menlo Park, CA (US); Justin Mckinlay, Surrey Hills (AU)

(73) Assignee: ACONEX LIMITED, Melbourne, Victoria (AU)

(21) Appl. No.: 14/129,892

(22) PCT Filed: Jun. 29, 2012
(86) PCT No.: PCT/AU2012/000766

§ 371 Date: Dec. 27, 2013

Related U.S. Application Data
(60) Provisional application No. 61/503,530, filed on Jun. 30, 2011.
(60) Provisional application No. 61/503,542, filed on Jun. 30, 2011.
(60) Provisional application No. 61/504,309, filed on Jul. 5, 2011.

(51) Int. Cl. G06F 17/30

(52) U.S. Cl. CPC G06F 17/30389
USPC 707/765

(57) ABSTRACT

An information management system comprising a data comparison module, a local data storage, a remote data storage, a user interface for requesting information, optionally a communications module and optionally a criterion analyser to analyse one or more criteria and thereby enable creation of one or more suitable templates wherein: the data comparison module enables re-finement of information queries without the need to undertake one or more of rebuilding, re-categorizing or re-indexing the information; the communications module facilitates communication between participants in the system; one or more methodologies may be used to access the information depending on the context; and transfer of information between the remote data storage and local data storage is proactively managed according to one or more criteria.

### BACKGROUND OF THE INVENTION

One of the most valuable elements of any business is the accumulated experience, knowledge and relationships held by the people that operate the business. Those elements comprise significant and valuable know-how regarding how to operate the business, but also usually provide a significant competitive advantage in sourcing information and leads for new potential customers and suppliers.

When the operator of a business leaves, often the accrued experience and relationships also leave—it's unusual for such things to be documented and even if they were, usually very difficult to hand over. Further, when a new business is established, without retaining a person with accrued knowledge or relationships, there is no current efficient method to acquire such experience.

This issue is particularly relevant to small businesses who deal with many different suppliers, such as construction suppliers who often engage subcontractors to do discrete works on an ad hoc basis. Without established relationships it can take significant trial and error to find a stable, reliable and good quality team of sub-contractors to cover each aspect of the required scope of works. Further, businesses with significant relationships often receive many more referrals and without experience and established relationships it is difficult to obtain significant referrals.

Information management systems comprising software applications may be useful in creation, management and use of such information. Such applications however have become increasing complex, providing the user with many different configuration options. However the increasing complexity and number of options has meant that software can be increasingly difficult and time consuming to use. Even for expert users who understand the different options and are familiar with the way in which they are presented by the software, the number of different options can mean that simple tasks or configurations can take longer to complete or set-up than might be possible through a bespoke approach.

There are a number of known methods to address this issue. For example, some software vendors produce different versions of the same software, one version being aimed at novice users (presenting only those options a novice user is likely to be interested in) and another being aimed at expert users (presenting all available options). However this method does not successfully address the issues that sometimes it is more efficient even for expert users to use a more streamlined interface for simple tasks.

Another commonly used method is to provide a number of pre-configured templates for different tasks or environments, which the user can select. In this way an expert user may select a complex configuration when required to complete complex tasks and a simple template when required for simple tasks. However this method is usually not suitable for novice users who are not sufficiently experienced to determine which pre-configured template to select. Further, this method relies on appropriate templates being constructed before time.

Such software applications could operate locally on the client or be hosted on a network (often referred to as “software as a service” or “cloud computing”). Hosted applications are becoming more popular as network performance improves and bandwidth cost reduces in many locations around the world. They provide significant benefits in that processing can be done centrally, significantly reducing the local client requirements and enhancing access by remotely located end users.

However, in some geographies and circumstances hosted applications (particularly those which are data intensive) are not desirable due to no network connectivity, slower network connectivity than required or desirable or relatively expensive bandwidth.

These issues are particularly acute for, as one example, companies involved in construction projects. Such projects typically involve a number of different remotely located parties (some of whom may not have any, consistent, fast or commercially cost effective Internet access) and a number of large data intensive documents (such as CAD drawings). Some particularly large construction projects are undertaken in geographies where Internet access is relatively expensive.

Further, modern features of hosted applications such as messaging, centrally controlled security roles and permissions and managing multiple document revisions across multiple party edits do not translate or translate appropriately to locally hosted applications.

The reference to any prior art in this specification is not, and should not betaken as, an acknowledgement or any form of suggestion that the prior art forms part of the common general knowledge.

### SUMMARY OF THE INVENTION

According to one aspect of the invention there is provided a system for managing information comprising a data comparison module and optionally a communications module wherein the data comparison module enables refinement of information queries without the need to undertake one or more of rebuilding, re-categorizing or re-indexing the information and wherein the communications module facilitates communication between participants in the system.

The system may be adapted for handling tender information and/or sharing information between a customer and a supplier and it may be adapted to create a request for tender from a set of information. Information relevant to a request for tender may be interactively displayed to an end user. The information may also include potential recipients of a request for tender.

A potential supplier may be selected in any suitable way, for example: automatically from a database or interactively by a user.

Information may be selectively shared between a customer and a supplier and it may be automatically validated against a database which is optionally authoritative.

In the present system, a tenderer may respond to a request for tender and one or more documents may be created from information stored or exchanged between parties in the system.

Documents may be of any suitable type, for example contractual, architectural, project management or other documents.

In one embodiment, a data comparison module comprises of local data storage, remote data storage and a user interface. Optionally, the user interface may provide a system for creating a template comprising a criteria analyser to analyse one or more operational criteria and thereby enable creation of one or more suitable templates.

In one aspect of the invention there is provided a method for managing information comprising receiving an information query, refining the information query without undertaking one or more of rebuilding, re-categorizing or re-indexing the information; and optionally facilitating communication between a plurality of participants in an associated information management system.

The system may also handle tender information and/or sharing information between a customer and a supplier and it may create a request for tender from a set of information. Information relevant to a request for tender may be provided in any suitable form, for example it may be interactively displayed to an end user. The information may include potential recipients of a request for tender and a potential supplier may be selected in any suitable way, for example, automatically from a database or interactively by a user.

The method of this aspect may allow information to be selectively shared between a customer and a supplier. The information may also be validated, for example automatically validated against a database which is optionally authoritative.

One or more documents may be created from information stored or exchanged between parties in the system.

In another aspect of the invention there is provided an information management system comprising a local data storage, a remote data storage, and a user interface for requesting information wherein one or more methodologies may be used to access the information depending on the context. In another, there is provided an information management system comprising a local data storage, remote data storage, and a user interface for requesting information wherein transfer of information between the remote data storage and local data storage is proactively managed according to one or more criteria

In some embodiments, at least one copy of a document stored on the remote data storage may also be stored on a local data storage. A document may be stored in the local data storage based on one or more criteria, which may be dynamically adjusted. Authentication and/or security parameters which for example may be stored on the remote data storage may be used to determine whether an end user may access particular information, such as a document.

Documents may be copied in any suitable way, for example they may be proactively copied to the local data store depending on one or more parameters, which may be dynamically adjusted.

A communications component may also be provided to communicate with another system to deliver a document to a user interface via a preferred path depending on one or more set criteria, which may be optionally dynamically adjusted. The system may also enable or provide offline access to information through a standardised interface.

In another aspect there is provided an information management method comprising the steps of: receiving a request for information from a remote data storage, analysing the context of the request and based on the analysis, selecting an information transfer methodology. Another aspect provides an information management method comprising the steps of: receiving a request for information from a remote data storage, analysing the request and proactively managing transfer of information based on one or more criteria.

The method may include the step of storing on a local data storage at least one copy of a document stored on the remote data storage. There may be an additional step of selectively storing a document in the local data storage based on one or more criteria, which may be dynamically adjusted. Authentication and/or security parameters which may be stored on the remote data storage may be used to determine whether an end user may access particular information, such as a document.

Documents may be copied in any suitable way, for example they may be proactively copied to a local data store depending on one or more parameters, which may be dynamically adjusted. The method may also comprise communicating with another system to deliver a document to a user interface via a preferred path depending on one or more criteria, which may be dynamically adjusted. The method may also provide offline and optionally read-only access to information through a standardised interface to enable access, for example, if the remote system is inaccessible.

Another aspect is a system for creating a request for tender from a minimum set of information. Additional information may optionally be obtained regarding the tender from a database and information relevant to a request for tender may be interactively displayed to an end user. Any suitable types of information may be used, including potential recipients of the request for tender

In one embodiment of this aspect, the data comparison module comprises of local data storage, remote data storage and a user interface. Optionally, the user interface may provide a system for creating a template comprising a criteria analyser to analyse one or more operational criteria and thereby enable creation of one or more suitable templates.

In another aspect of the invention, there is provided a system or method for the sharing of information between customers and suppliers comprising a data comparison module to enable refinement of information queries without the need to undertake one or more of rebuilding, re-categorizing or re-indexing the information. In some embodiments, information may be selectively shared between customers and suppliers. In some embodiments, shared information may be automatically validated against an authoritative database. In some embodiments, tenderers may respond to requests for tender—for example via a communications module.

In some embodiments, packages of contractual documents are created from information stored or exchanged between the contracting parties in the system.

In some aspects, the present invention may provide one or more of:
(a) a method of recording, organising and sharing business knowledge while retaining confidentiality and privacy;
(b) a convenient method for using shared knowledge to assist a customer to create an invitation to tender, including using accrued experience to create price quotes and shortlists of potential suppliers;
(c) a convenient method for a customer to create and deliver invitations to tender to potential suppliers;
(d) a convenient method for suppliers to be notified regarding and to receive invitations to tender from potential customers;
(e) a convenient method for suppliers to review invitations to tender as compared to previous invitations to tender and aspects of accrued knowledge, including pricing, other suppliers and regulatory information;
(f) a convenient method for suppliers to respond to invitations to tender, whether to request further information, reject the invitation or respond to the invitation with a tender; and
(g) a convenient method to create contractual documentation from information contained within the system, and optionally including information from responses to a tender

Another aspect of the invention is a data comparison system comprising local data storage, remote data storage, and a user interface for requesting information wherein transfer of information between the remote data storage and local data storage is proactively managed according to one or more criteria. A further aspect of the invention is a method of information management comprising the steps of requesting information from remote data storage, analysis of the information transfer context and choice of an information transfer methodology

In some embodiments, the system uses authentication and security parameters stored on the remote data storage to determine whether an end user can access a particular document. Documents may also be proactively copied to the local data store depending on certain parameters, which may be dynamically adjusted in some embodiments.

In another aspect, there is provided a system for providing offline access to data through a standardised interface.

In some embodiments, the present invention addresses issues in access to remotely stored electronic data by blending different types of access methodologies seamlessly depending on the characteristics of the end user and their situation while at the same time managing issues such as security and document revisions.

The user interface in accordance with the present invention provides a system for creating a template comprising a criteria analyser to analyse one or more operational criteria and thereby enable creation of one or more suitable templates.

In a further aspect of the invention, there is provided a system for creating a template comprising a criterion analyser to analyse one or more criteria and thereby enable creation of one or more suitable templates.

The term ‘template’ as used herein is used broadly to describe an interface for human use.

The system may also comprise a template element store, an element selector and a rendering engine, wherein the element selector selects one or more template elements based on output from the criterion analyser for rendering by the rendering engine. In some instances, an element is selected based on relevance to one or more of information provided by a user or information derived from information provided by an end user. Elements may comprise any suitable thing, for example, they may comprise configuration information for a software application and/or components of one or more documents.

In one aspect of the invention, there is provided a method for creating a template comprising analysing one or more criteria and creating one or more suitable templates. The method may comprise the steps of storing a template element in a template element store, selecting an element from the template element store based on output from the criterion analyser and rendering a template from one or more selected template elements. An element may be selected based on relevance to either information provided by a user or information derived from information provided by an end user. Elements may comprise any suitable thing, for example they may comprise configuration information for a software application and or components of one or more documents.

The current invention provides a convenient system for dynamically identifying and creating an optimal template configuration required by the end user based upon a minimal set of input parameters. Further, the current invention provides for a convenient method of sharing and updating individual template elements, which are dynamically used by the system where required to create an optimal outcome.

In a further aspect, there is provided an information management system comprising a data comparison module, a local data storage, a remote data storage, a user interface for requesting information, optionally a communications module and optionally a criterion analyser to analyse one or more criteria and thereby enable creation of one or more suitable templates wherein: the data comparison module enables refinement of information queries without the need to undertake one or more of rebuilding, re-categorizing or re-indexing the information; the communications module facilitates communication between participants in the system; one or more methodologies may be used to access the information depending on the context; and transfer of information between the remote data storage and local data storage is proactively managed according to one or more criteria

In another aspect, there is provided a method for managing information comprising: receiving an information query; refining the information query without undertaking one or more of rebuilding, re-categorizing or re-indexing the information; analysing the context of the request and based on the analysis selecting an information transfer methodology; analysing the request and proactively managing transfer of information based on one or more criteria; optionally creating a template by analysing one or more criteria and creating one or more suitable templates; and optionally facilitating communication between a plurality of participants in an associated information management system.

Throughout this specification (including any claims which follow), unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

### BRIEF DESCRIPTION OF DRAWINGS

FIG. 1 shows a typical embodiment of one aspect of the invention in a client server architecture

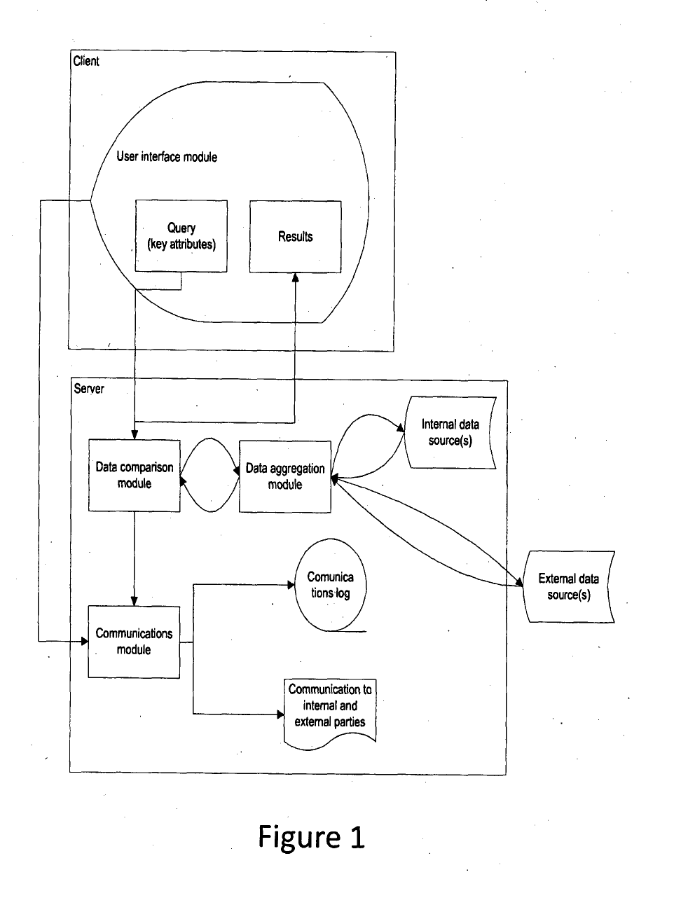

FIG. 2 shows in one aspect of the invention an example search for a supplier based on key attributes

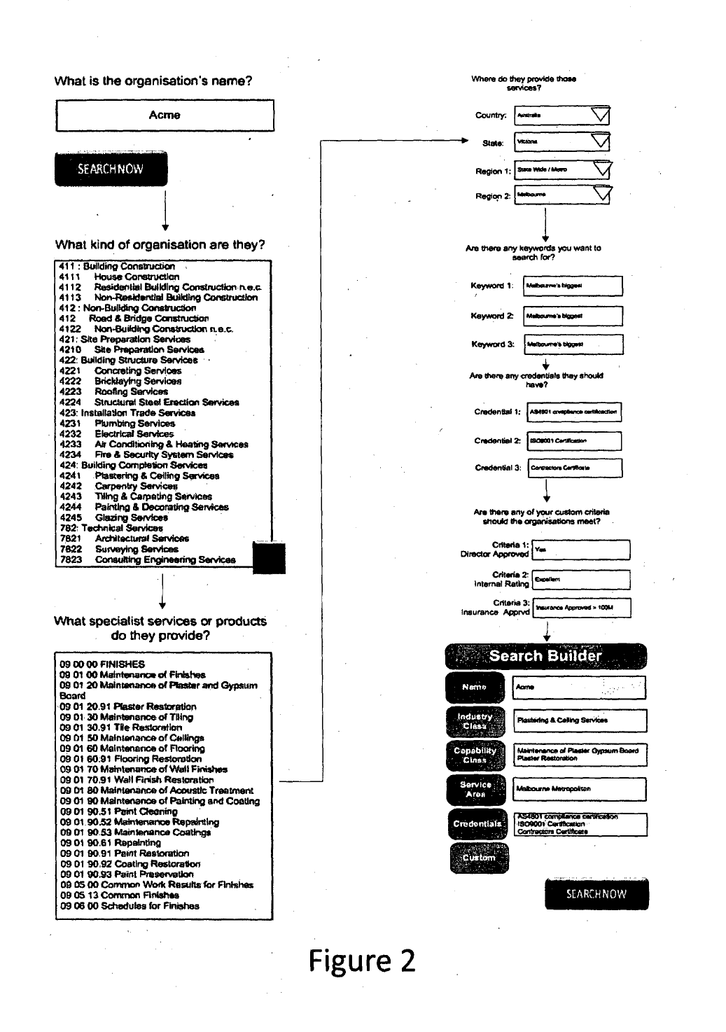

FIG. 3 shows in one aspect of the invention an example of a real-time search for supplier based on key attributes and display of further key attributes derived from the data aggregation module

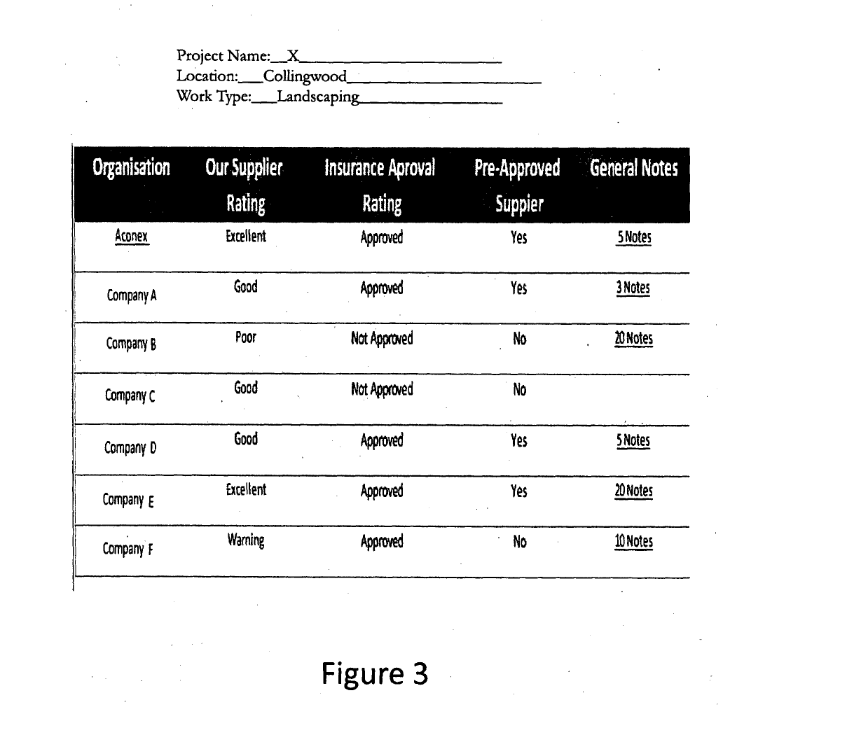

FIG. 4 shows in one aspect of the invention an example for creation of an invitation to tender to an external party

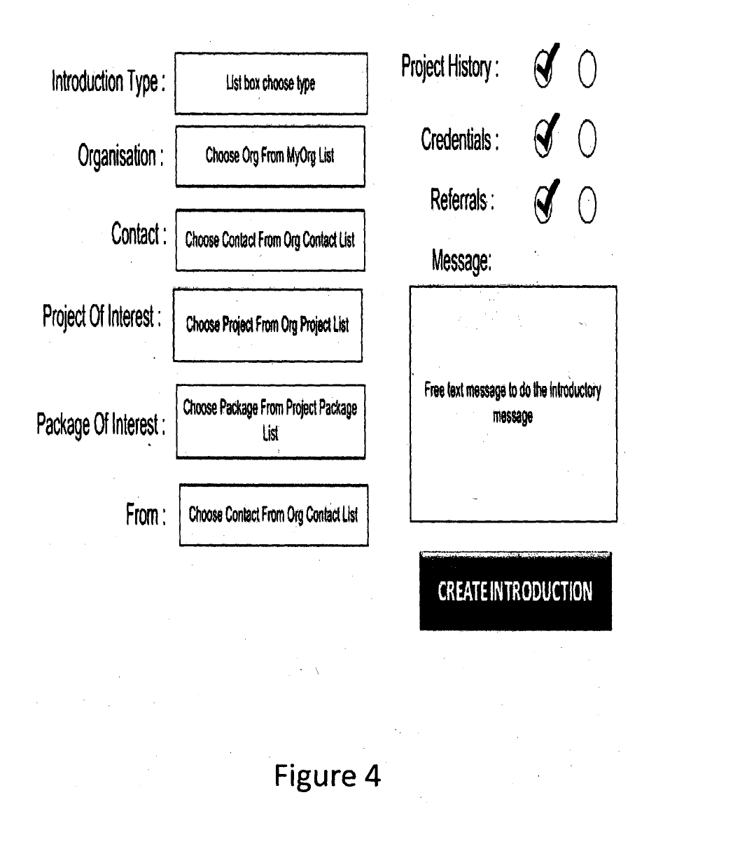

FIG. 5 shows in one aspect of the invention a search for invitations to tender

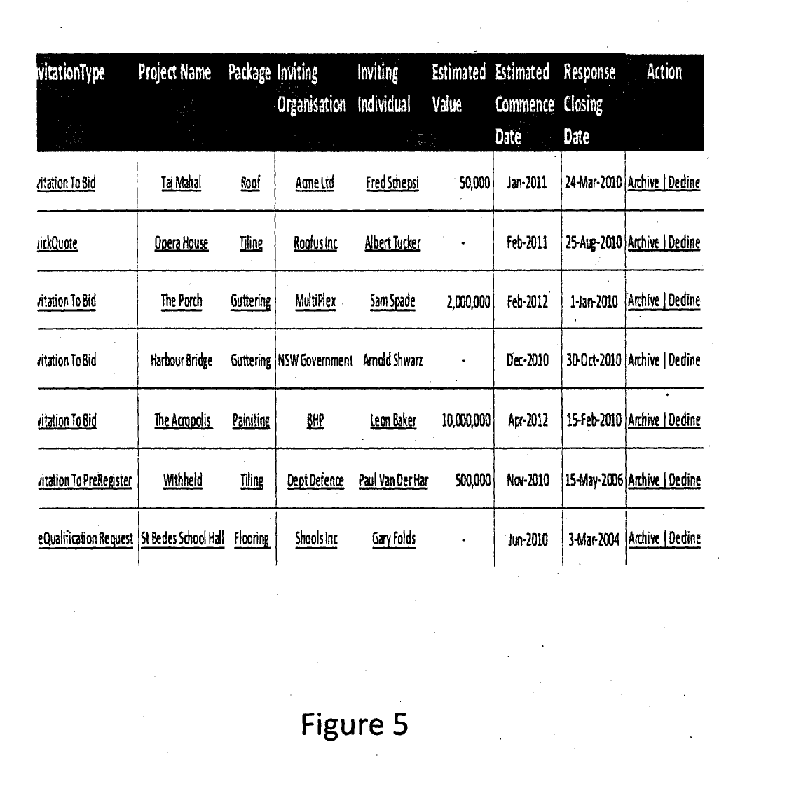

FIG. 6 shows in one aspect of the invention an exemplary software application that can be used in the current invention

FIG. 7 shows in one aspect of the invention an example of a template creating user interface

FIG. 8 shows in one aspect of the invention an example of the user interface in accordance with the invention

FIG. 9 shows another embodiment of the user interface in accordance with the invention

### DETAILED DESCRIPTION OF EXEMPLARY EMBODIMENTS

It is convenient to describe the invention herein in relation to particularly preferred embodiments relating to businesses in the building and construction industry. However, the invention is applicable to a wide range of industries and it is to be appreciated that other constructions and arrangements are also considered as falling within the scope of the invention. Various modifications, alterations, variations and or additions to the construction and arrangements described herein are also considered as falling within the ambit and scope of the present invention.

Information management System

In this example embodiment, the system comprises the following modules:
(a) data aggregation module;
(b) data comparison module;
(c) communications module; and
(d) user interface module.

A data aggregation module may be a conventional electronic data store (such as a computer database or file system) and is used by the system to store and retrieve information.

The data comparison module operates comparison functions on the data such that it aggregates relevant data from the data aggregation module. For example, the data comparison module may request all suppliers in a geographic area from the data aggregation module, but apply a filter combining data from external sources to narrow the returned dataset to be more relevant to the requested data. In this way optimisations and queries can be modified in near real-time and continuously refined and added to using new data sources without rebuilding, re-categorising or re-indexing the entire system and optionally without rebuilding, re-categorising or re-indexing components of the system.

The communications module facilitates communication between participants in the system. The communications module can be implemented using a conventional communication protocol and optionally records information in relation to communications via a communications log available in the system.

The user interface module is used to display information and receive input (including requests) from the end user. It is convenient to describe the user interface module as being a website, though any convenient method of display and input could be used.

In a typical embodiment information accessible to the data aggregation module, data comparison module and communication module might be stored in electronic form in a remote database such as a server accessible by a computer on a network or through any hosted interface. Remote access to the information (here, documents) is provided through a user interface layer separate from the remote data store which accesses information stored in the remote data store over the network using any suitable method.

Again it is convenient to envisage the modules to be configured in a conventional arrangement for a website, but other arrangements of the modules would also operate as desired (such as all modules being located on a client computer and operating in a peer-to-peer environment via the data comparison module).

Access to Electronic Information

Information pertaining to the business can be stored in an electronic form which can be accessed locally or by means of a computer on a network or through a hosted application. In one preferred embodiment information such as a set of documents is stored in electronic form in a remote database such as a remote data store in a suitable electronic file format. Remote access to the information (here, documents) is provided through a user interface layer separate from the remote data store which accesses information stored in the remote data store over the network using any suitable method.

The user interface layer can optionally access the information in the remote data store indirectly by requesting the information from an intermediate software application rather than the remote data store.

In some embodiments, there is provided an information management system comprising a local data storage, a remote data storage, and a user interface for requesting information wherein one or more methodologies may be used to access the information depending on the context. In some embodiments, there is provided an information management system comprising a local data storage, remote data storage, and a user interface for requesting information wherein transfer of information between the remote data storage and local data storage is proactively managed according to one or more criteria.

In some embodiments the remote system is able to still maintain an audit trail of the access via the local system and in some embodiments the local system is able to support multiple users without compromising security.

The skilled addressee will appreciate that in some configurations, the data transfer rate from the remote data store is noticeably slower than the local data store and thereby particularly understand various benefits of the invention in that light.

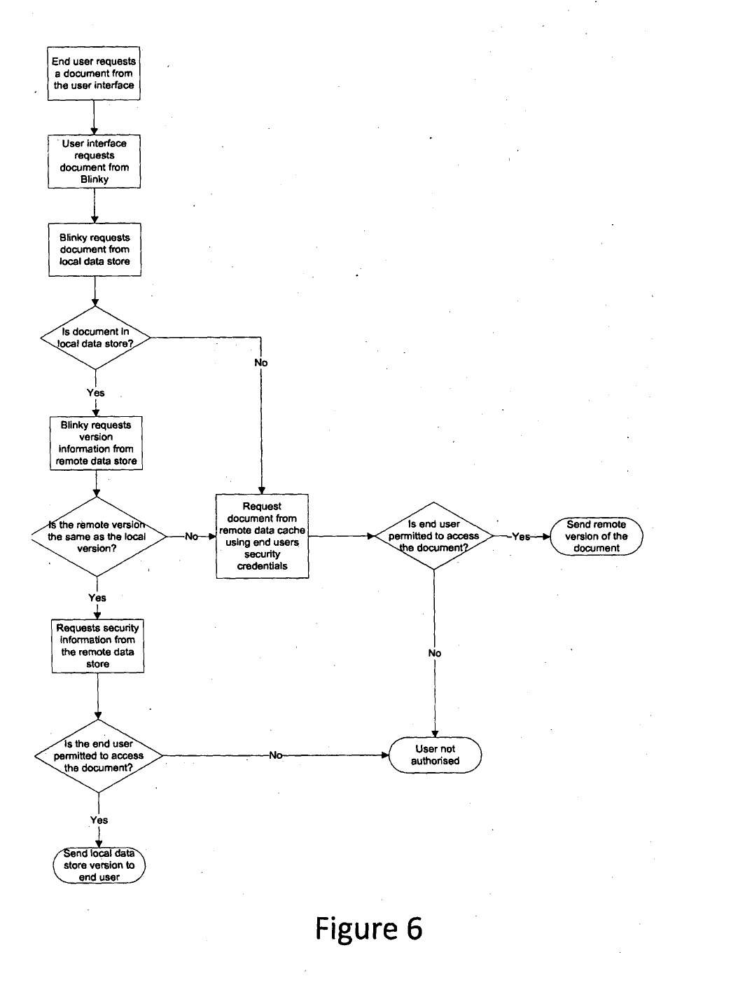

For ease of reference, the exemplary software application described herein is referred to as ‘Blinky’ (See FIG. 6). The user interface layer may be configured so that, using a series of probing network requests, it may attempt to discover the existence of a software application such as Blinky and automatically configure itself to use a conveniently located installation.

In this preferred embodiment the software application, Blinky is located within the local network of the relevant end user such that access to Blinky is sufficiently fast and cost effective in accessing and delivering data. In some embodiments, the software application has a local data store in which it can retain a copy of information such as one or more documents.

As a non-limiting example, an end user may access a stored electronic document in the following way (FIG. 6).
1. The end user navigates to the document in the user interface and uses any convenient method to request the document;
2. Assuming the user interface is configured to use Blinky (having either been manually configured or through an automatic configuration process), it requests the document from Blinky;
3. Blinky checks to see if the document is in the local data store;
4. If the document is in the local data store:
   a. Blinky requests the version information from the remote data store;
   b. If the document exists in the remote data store and is the same version as the local data store version then:
      i. Blinky requests security information from the remote data store regarding the document;
         1. If the user requesting the information is permitted to access the document, Blinky sends the document to the user interface that requested the document from the local data store without requesting the full document from the remote data store;
         2. Otherwise, Blinky returns an appropriate “not authorised” error.
   c. Otherwise
      i. Blinky requests the document from the remote data store using the security credentials of the user;
      ii. If the remote data store returns a document, Blinky stores that document in the local data store and serves it to the user interface that requested the document;
      iii. If the remote data store returns an error in any of the above steps (either no document exists or the end user is not authorised), Blinky passes the error through to the end user.
5. Otherwise
   a. Blinky requests the document from the remote data store using the security credentials of the user;
   b. If the remote data store returns a document, Blinky stores that document in the local data store and serves it to the user interface that requested the document;
   c. If the remote data store returns an error in any of the above steps (either no document exists or the end user is not authorised), Blinky passes the error through to the end user.

In this way Blinky is able to quickly and cost effectively deliver documents to the end user.

As a further non-limiting example, an end user may access a stored electronic document in the following way.
1. The end user navigated to the document in the user interface and uses any convenient method to request the document with a particular set of attributes;
2. Assuming the user interface is configured to use the local data store (having either been manually configured or through an automatic configuration process), it requests the document from the local data store;
3. If a document potentially matching the request is located in the local data store:
   a. The local data store requests additional information from the remote data store, which may include version information and other attributes;
   b. If the document exists in the local data store and has the same matching attributes as the remote data store, then:
      i. The local data store sends the user's security information with a request to access the document;
      ii. If the remote data store confirms the user is permitted to access the document:
         1. The remote data store assumes the user has accessed the document and updates an audit log to reflect that operation
         2. The local data store sends the document to the user interface that requested the document from the local data store without requesting the full document from the remote data store;
      iii. Otherwise,
         1. The remote data store records in the audit log an unauthorised access by the user that was rejected
         2. The local data store returns an appropriate “not authorised” error to the user interface.
4. If there was no matching document, or the document was found to have different attributes
   a. The local data store requests the document from the remote data store using the security credentials of the user;
   b. If the remote data store authorises the user to access that document:
      i. The remote data store will update the audit log to record the user has downloaded the document
      ii. The local data store will then be able to retrieve that document from the remote data store, store the document and serve the document to the user interface. (The system may for example stream the document to the user as it is downloaded, in such cases it does not have to wait until the entire document is stored locally before sending it to the user.)
   c. Otherwise
      i. If the document exists but the user was not authorised to access the document, the remote data store updates the audit log to reflect there was an unauthorised attempt
      ii. The remote data store responds with an appropriate error which the local data store passes onto the end user.

In this way the Local Data sore is able to quickly, securely and cost effectively deliver documents to the end user.

In some embodiments, the invention may determine whether document requests are for static documents or dynamic interaction with an application. If a request is for a dynamic interaction, the request is passed through to the remote application rather than being dealt with by the software application (such as Blinky).

In some embodiments, a software application may pro-actively download documents which are more likely to be requested by end users. For slower network connectivity, this can avoid delays when a document is first requested. Likelihood of requesting a document can be determined in any suitable way, including for example:
1. Heuristic categorisation of documents
2. Measuring historical document frequency
3. Measuring historical document frequency by type
4. End User characteristics and document types (for example, on a construction project an engineer is likely to access particular documents which are different from the documents accessed by a construction contractor)
5. End User interaction (for example, the software application may proactively download documents which are currently displayed as an option for access by the end user, which is particularly helpful to reduce latency where a network connection is slow but bandwidth is inexpensive)
6. Time and date (for example, the software application may refresh large documents outside of working hours)

In order to sustain end user performance, pro-active downloading of documents can be throttled or turned off depending on a number of criteria, including for example:
1. The current document request load
2. The current bandwidth utilised by interactive tasks (so as to promote interactive response times rather than downloading documents)
3. The current document fault rate (that is, the number of times the software application needs to request a document from the remote data store)
4. Where bandwidth costs are prohibitive (for example, it could be turned off entirely or only operated during “off-peak” hours to reduce cost)
5. Time and date schedules

In order to predict whether to access and proactively download a particular document; a document cost may negotiated between the local document store and remote document store. This negotiation is unique to each installation and can be refreshed multiple times per day if circumstance change. The local document store and the remote document store each contribute characteristics regarding the document to the negotiation, including for example:

1. The size of the document (remote document store)
2. The speed of the internet connection (local document store)
3. The cost of bandwidth (local document store)
4. The frequency of accessing that document by others outside the local network (and thereby measure the likelihood of there being a conflict in document revisions) (remote document store)
5. The frequency of access to that document within the local network (local document store)

If the negotiated document cost meets certain criteria (which may be expressed as a multi-dimensional threshold) then the document is marked as a candidate for pro-active download.

In addition, such metrics are used to determine when a document should be pushed back up to the remote data store, including the likelihood that another revision will be made locally before another revision is made in a different remote location.

As a further optional feature, the invention may store a hash table of common content (when viewed in a binary manner or at a higher level) between documents locally and only transmit an encoded copy of the document between the remote and local document store. This is particularly useful when a number of similar documents are used by the local document store.

In some embodiments, if the local data store has an older version of the document, the remote data store could send only the differences between the two versions.

In some embodiments, the invention may also reconcile documents which have been simultaneously downloaded to multiple local data stores, enabling multiple installations to work together. This is important where the invention is embodied in a network device which is portable and may already have a number of documents in its local document store. Working together, such implementations can be used remotely, then attached to the same network seamlessly taking advantage of the aggregated documents in each respective local document store. Multiple installations may for example work together in the following way (using Blinky as an example):
1. When a Blinky installation is activated it first attempts to discover other Blinky installations using known techniques for sending network broadcast messages.
2. If no other Blinky installation is discovered, Blinky continues to operate in stand-alone mode.
3. If another Blinky installation is discovered, the Blinky installations record the existence of each other on the local network.
4. On discovery, each Blinky installation exchanges with the other a list of the documents in the local document store.
5. When a document is requested from one Blinky installation, it performs the normal operations regarding security and whether the document exists in the local document store. If at any stage a Blinky installation requires access to the document from the remote document store, the Blinky installation consults the list of documents stored in local Blinky installations and, if a document exists, download it from the local Blinky installation rather than the remote document store.

In some embodiments, multiple installations may for example work together in the following way (also using Blinky as an example):
1. When a Blinky installation is activated it first attempts to discover other Blinky installations using known techniques for sending network broadcast messages.
2. If no other Blinky installation is discovered, Blinky continues to operate in stand-alone mode.
3. If another Blinky installation is discovered, the Blinky installations record the existence of each other on the local network.
4. When a document is requested from one Blinky installation that does not have the correct document, the request could be broadcast to other Blinky installations to determine if the document is already held locally in another data store. If another local data store does hold the document, the end user request can be redirected to the other local data store, which would still perform the same authentication checks, but would avoid copying the file from the remote data store.

A system according to the invention may also contemplate operating modes where network connectivity is not available, either for short or longer periods.

In the case of short periods of disconnected operation, the system may for example function as normal; however requests for documents from the remote data store may in this instance return an error indicating that those documents are currently not available.

A disadvantage of some such approaches is that it may not be possible to access remotely hosted elements of the user interface without network connectivity. In such cases the system can operate a “local copy” system. Local copy is a logically separate operating mode from that exemplified herein as Blinky in that local copy is a complete copy of the remote document store on a local computer together with a modified user interface module which looks similar to the complete user interface module, but is simpler and provides only for read access.

User Interface

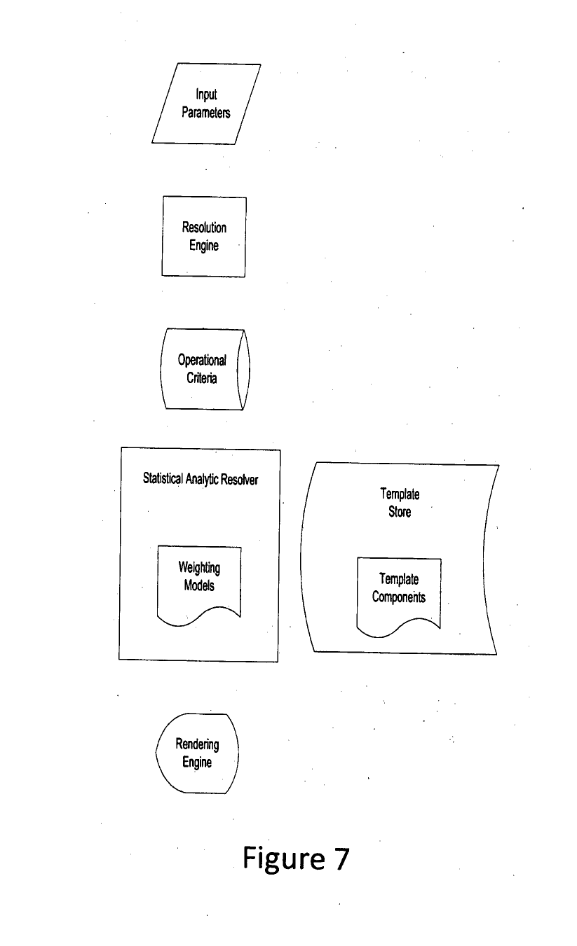

In some preferred embodiments, the system comprises at least five components (FIG. 7).
(a) Operational Criteria
(b) A Resolution Engine
(c) A Template Store (containing Template Components described in a Description Language)
(d) A Statistical Analytic Resolver (containing zero or more Weighting Models)
(e) A Rendering Engine

In these embodiments, each of the five components are used, for example, either in parallel or in a particular, order, and for example in series, to resolve an optimal configuration of Template Components for implementing Operational Criteria based on a number of input parameters.

### Operational Criteria

The intent of the system is to create an optimal template based on the Input Parameters provided. The Operational Criteria define the criteria for determining whether a particular template is the optimal implementation.

For example, one optimal implementation may be to ensure that use is made of all Input Parameters provided by the end user, and such a requirement would be recorded in the Operational Criteria. An example alternative optimal implementation may be one which uses all parameters, whether they were provided by the end user or resolved using another method (such as by the Resolution Engine). A further example of an Operational Criterion is one that produces a template with the least number of steps to completion. Any number of different criteria can be used as Operational Criteria.

In some embodiments, if no Operational Criteria are provided, the system will produce all possible templates based on the Template Store and the Input Parameters.

### Resolution Engine

In some embodiments, a Resolution Engine is used to expand the Input Parameters to include information which was not first entered by an end user. Such further information may be obtained from public and/or private information stores, such as company registers, internal documents, etc.

For example, if the name of the end user is passed into the Resolution Engine, the engine may for example query public and/or private databases to determine the industry in which the end user works, the typical projects in which the end user is involved and the geographical regions in which it is involved. All of that information would then be added to the Input Parameters first provided by the end user (but marked as being resolved from the Resolution Engine) for further use by the system.

### Template Store

Some embodiments comprise a Template Store which is a storage system (such as a database or computer file system) which contains Template Components. Each Template Component is described in a Description Language.

### Template Components (or Template Elements)

In some embodiments, Template Components may contain discrete elements of a document or project configuration.

A Template Component (or Template Element) may be characterised by a number of required input parameter conditions and input parameter information, each with different weightings based on importance to the Template Component. Further, each Template Component may name zero or more dependant Template Components as either being optional or required for the current Template Component.

As one example in the context of a document management system, there may be Template Components for the following elements of the system.

1. Email format for change requests
a. Required input parameter conditions: there is a project definition, the project definition can be modified, communication can be by email
b. Input parameter information: none
c. Dependant Template Components: none
d. Template Component: the format for the change request email

2. Regulatory requirements for construction projects in the Middle East
a. Required input parameter conditions: project is a construction project, location is Middle East
b. Input parameter information: none
c. Dependant Template Components: none
d. Template Component: regulatory business rules for construction projects

3. Currency conversion from USD to AUD
a. Required input parameter conditions: project has a cost; location is United States; location is Australia
b. Input parameter information: none
c. Dependant Template Components: none
d. Template Component: regulatory business rules for construction projects

### Description Language

In some embodiments, each Template Component is described using a Description Language. The Description Language can be any computational language, but is preferably a language that supports conditional and branching constructs.

The Description Language optionally supports constructs that describe tasks that must be done in serial and tasks that may be done in parallel.

The Description Language must contain constructs which instruct the Rendering Engine to obtain further input from the user. Such constructs would ideally be implemented in a high level language, which might include HTML, XML or similar mark-up.

### A Statistical Analytic Resolver

In some embodiments, a Statistical Analytic Resolver is used to create a linear equation of parameters provided and, using regression analysis and applying the weighting model, to select an optimal combination of Template Components to achieve the Operational Criteria.

### Weighting Model

In some embodiments, a Weighting Model describes the importance of different factors in selecting the Template Components.

### Rendering Engine

In some embodiments, a Rendering Engine provides a means for executing a Description Language, displaying requests for further information and results and for interfacing with external systems which make use of the resulting template or configuration information.

### An Example Embodiment In a simple embodiment, the system may for example comprise:

(a) The Input Parameters,
(b) One Template Component,
(c) which is described using the Description Language,
(d) and stored in the Template Store.

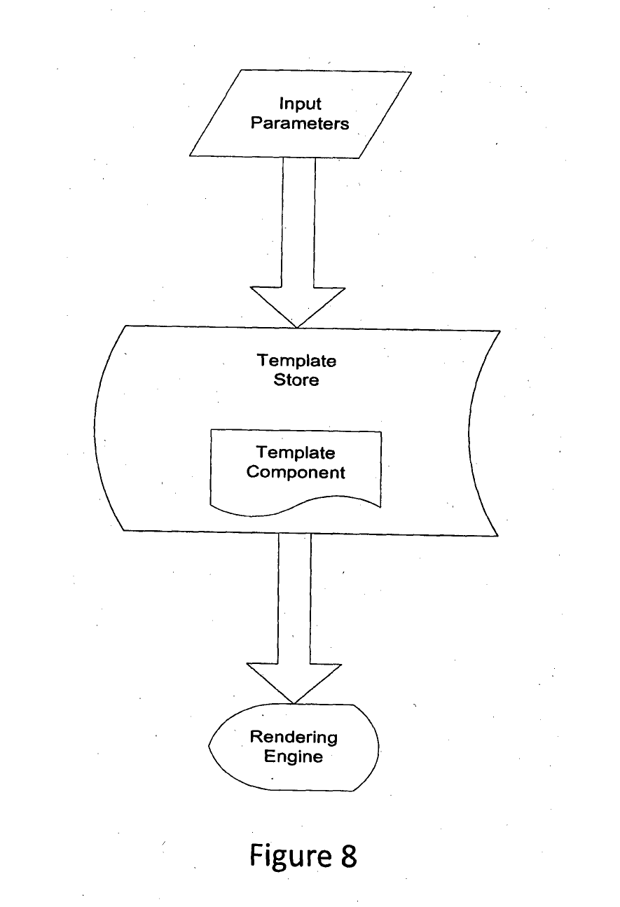

In such a case the system might for example simply invoke the one Template Component, there being no other choices (FIG. 8).

Other simple embodiments of the system involve multiple Template Components, but each within discrete areas which do not overlap. In these cases, depending on the input from the end user, a single Template Component would be selected end execute.

In still further simple embodiments a number of pre-configured templates could be stored as Template Components and the end user could select from one of the Template Components. In the context of a construction project, such templates could represent different projects, including:
Construction—Residential
Construction—Commercial
Construction—General
Infrastructure—Road
Infrastructure—Rail
Infrastructure—Airport
Infrastructure—General
Engineering—Mining
Engineering—Gas
Engineering—General

Once a template has been selected, a Rendering Engine may step through each element of the template, requesting further information from the end user where necessary. Such steps might include:

Project Details
Name, Location
Invite users to project

Mail Types
Assign to correct org roles

Entered attribute values
Mandatory vs. non-mandatory

What forms will be used for what mail types
Confirm the form process is correct for the project

Document Types
Assign types to correct org roles

Document Fields
Confirm field name
Confirm enabled fields
Confirm mandatory fields
Enter field values

Confirm access control groups
Assign users to groups

Confirm access control rules
Assign permission to rules

Confirm document numbering scheme setup
Assign document types to schemes

Confirm workflow templates
Assign steps to users

### A More Complex Embodiment

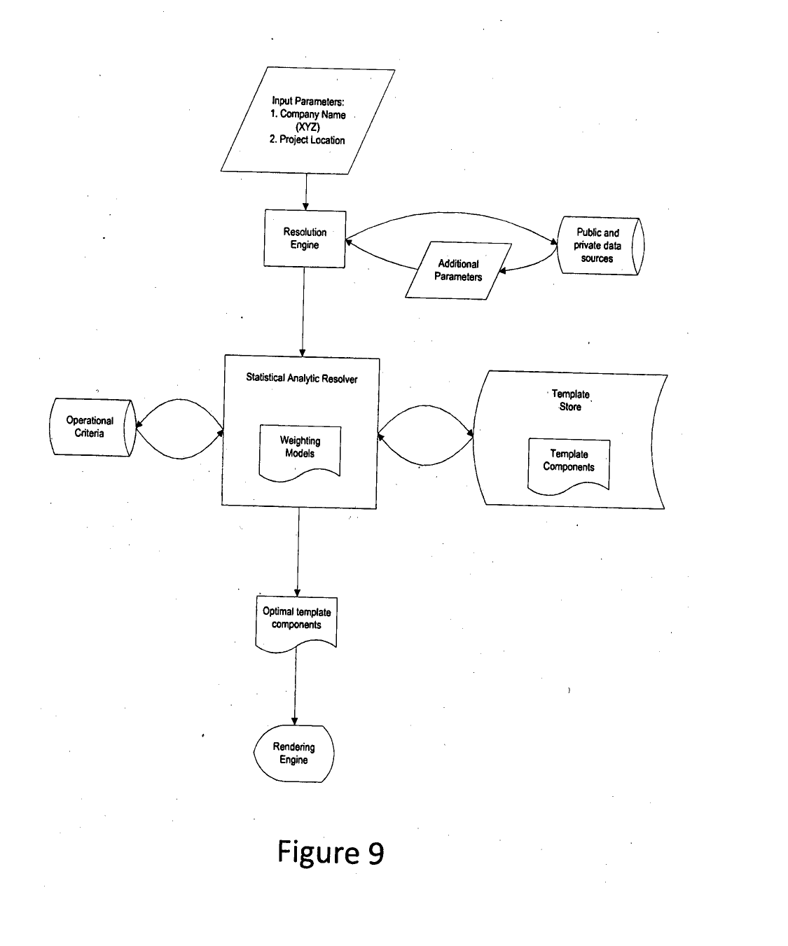

A more complex embodiment (FIG. 9) might for example comprise:
(a) Input Parameters
(b) Operational Criteria
(c) A Resolution Engine
(d) A Template Store (containing Template Components described in a Description Language)
(e) A Statistical Analytic Resolver (containing zero or more Weighting Models)
(f) A Rendering Engine

Prior to the system being used by an end user the Operational Criteria are optimally established, in this case for example purposes we will use an Operational Criteria as being the optimum template based on all information provided by the system.

Also prior to the system being used the Template Store is optimally loaded with a number of Template Components, described in the Description Language and containing the various required input parameters conditions, input parameter information, dependant Template Components.

The system is started by passing to the Resolution Engine the minimum configuration parameters which are provided by the end user. In this example, the end user will pass in the company name (XYZ), the project location and that it would like to build a project.

The Resolution Engine takes the input parameters and attempts to collect further information based on the first set of parameters. The Resolution Engine consults a number of data sources, including private and public information stores to obtain further information based on the parameters passed in (“Additional Parameters”). In this example, the parameters are expanded in the following way:

1. Company name industry→(from a private database)→home location (from a public database)→number of employees (from a private database)→types of projects completed (from a private database)

2. Project location→industry (from a private database)→types of projects anticipated (from a private database)

The original parameters together with the Additional Parameters are passed into the Statistical Analytic Resolver (SAR). The SAR compares each of the original Input Parameters and Additional Parameters identified by the Resolution Engine to each of the required input parameters conditions for each Template Component in the Template Store. The system then uses regression analysis to identify the optimal set of Template Components which satisfy the Operational Criteria taking into account the required input parameter conditions.

In this example the parameters might match various Template Components, including a document library, email change control process, currency conversion and regulatory reporting component relevant to the location. Each of those components are compiled into an equation and the resolution of each is compared to the operational criteria, which in this case is a template based on all information provided by the system.

Once the optimal set of linear equations is determined and the Template Components are collected and ordered based on interdependency, the various components of that equation are then delivered to the Rendering Engine. The Rendering Engine will execute each of the Template Components using the Description Language defined within each component. Where parameters are required that are not part of the parameter set (either from the original parameters or the Resolution Engine parameters), there are conflicts in parameters which cannot be resolved or actions are required from the user, the Rendering Engine will display each of those issues to the user for resolution, either in the order defined by the Description Language or in the most efficient manner. Where possible, the Rendering Engine may provide the ability to delay further resolution of requested information until a later date.

End Users of the System

Typically end users of the system can be classified into two groups—customers (those looking seeking the services of others by tender) and suppliers (those looking to provide services to others).

### 1—Customers

A customer looking to source the services of third parties would typically create an account on the system by first accessing the user interface module which, where the system is embodied in a website, would be via a computer web browser. Creating an account may require the customer to input a minimum amount of information in order to uniquely identify the customer within the system and provide a desirable level of security. In one embodiment such minimum information would be a username (which must be unique) and password (which need not be unique). In another preferred embodiment the information required to create an account might include the following.

Organization Name

Company or business registration number

Trading Name

Full name of the account holders (first and last name may be entered into separate fields)

Telephone contact number

Email address (which is used as the unique username)

Password

Correct entry for a human challenge problem, such as recapture

The customer account information is stored in the data aggregation module and conventional access to customer account information is provided by logging into and out of the system via the user interface module.

After the customer account is created the user interface module then displays a number of options to the customer, including the ability to further customise the account information by changing, deleting or adding data, undertake research by querying the data aggregation module and data comparison module or create an invitation to tender.

(a) Undertake Research Using the Data Aggregation Module and Data Comparison Module

The data aggregation module contains information which is maintained by the system. This information includes information regarding each customer and supplier and any interactions between them. The information also contains information which is relevant to end users, such as pricing guides for work and materials. Finally, the data aggregation module also contains historical information regarding customers and suppliers, which is described in more detail below.

The data comparison module is an intermediate stage between the data aggregation module, external data sources and the end user query. Where information is not currently stored in the correct format to efficiently process a query submitted by an end user, or where the query results compile data from the data aggregation module and an external data source, the data comparison module manages the interconnection of those data sources and execution of the query.

The data comparison module can also be optionally configured not to display (but may use in its calculation) any information which is confidential.

Research can be conducted by passing queries to the data comparison module (which can be pre-formatted or can be constructed by the end user) and retrieving the results. An example of such a query may be to consider average tender pricing for work fitting a particular description.

Further, customers and suppliers may elect to contribute information about themselves to the data aggregation module for inclusion in query results. Examples of such information include compliance statements, insurance certifications, references, OHS accreditations, standard rates and list of completed projects.

(b) Create an Invitation to Tender

One example use of the system is to invite suppliers to tender for work to be performed for customers. The system enables the creation of an invitation to tender (including pricing and timetable information) using the benefit of information from the data aggregation module and data comparison module. In this way, customers have the benefit of retained knowledge and relationships without necessarily having to develop them themselves.

In one implementation, to create an invitation to tender the customer navigates to the system website, creates an account or logs into an existing account using the end user interface and selects “Manage Tenders Out” and then “Create Tender”. The system then requests from the customer a number of details, typically including the tender title, opening and closing dates of the tender process, the estimated value of the tender, location of the work and contact details of a person to discuss the tender. A typical example may include the following information—“construction of a residential house”, “Glen Iris, Victoria, Australia”, “June”. The information entered at this stage is referred to as the “key attributes” of the invitation.

The key attributes are interactively passed to the data comparison module as they are being entered by the customer. The data comparison module queries each of its available data sources (whether the data aggregation module or external databases) and compares each of the data elements which have sufficiently similar key attributes (based on simple matching, heuristic or regression analysis algorithms). The data comparison module then returns the similar results organised by similar key attributes.

The user interface module then displays the results as guidance on key attributes (for example, matches on “Glen Iris, Victoria, Australia” and “construction of a residential house” may have a strong connection with “November” rather than “June”) and may suggest other information which may not be apparent to the customer when planning the tender (such as the average invitation to tender price for similar projects, or the typical types of work packages each tender is divided into).

Examining each of the work packages presented by the data comparison module it is possible to compare key attributes between the current tender and others, for example comparing tender pricing between similar projects and inform likely cost of the current project.

The customer can then prepare the invitation to tender using the full suite of information available to it. Further details can be incorporated using any suitable data capture technique (including free-form text box, electronic document upload or structured forms).

Each tender is then optionally divided into packages, each package representing either the entire project scope of a discrete work, element. In the current example of a residential house construction work packages might include electrical, concreting and plumbing amongst others. A list of typical packages and typical costs associated with each work package based on the key attributes is displayed to the customer as guidance in preparation of each work package. The customer can also associate and optionally upload electronic documents to the system for each work package.

As each work package is prepared a shortlist of potential suppliers is displayed to the end user, which can be ordered and/or filtered by various attributes, including whether the supplier is part of the customer's network, whether the customer has dealt with the supplier before, a satisfaction rating as rated by the customer, a satisfaction rating as rated by others that have dealt with the supplier, availability based on the supplier's accepted and/or recorded commitments, location, legal or regulatory claims against the entity, financial standing, delivery on budget, delivery on time and any other attribute. In this way a customer has access to potential suppliers and significant details about each supplier's appropriateness for a particular job.

Once the work package is complete, it can be sent to each relevant supplier by means of selecting them using the user interface module and passing them, together with the information to send, to the communications module. Suppliers can be selected based on individual name, general criteria or custom assigned criteria created by the customer (such as a group of suppliers).

In addition to those suppliers already listed in the system, it is possible to send the invitation to suppliers not listed in the system. The system provides for such notification via conventional communication systems such as email and SMS and provides a notice that there is an invitation to tender waiting in the system and the supplier should create an account in order to view and respond to it. Such general links to can also be advertised on a non-specific basis (such as in a newspaper) so that a customer can advertise a link to a particular tender and anyone wishing to view and/or respond to the invitation can use the link to create an account and obtain the required access.

Further, it is optionally possible to mark an invitation to tender or work package as “public”, meaning that it will be displayed in various public directories and proactively suggested to suppliers for review and response.

### 2—Suppliers

A supplier looking for work would typically create an account on the system by first accessing the user interface module which, where the system is embodied in a website, would be via a computer web browser. Similar to a customer, creating an account involves entering at least sufficient detail to identify the supplier, such as a unique username and password (which doesn't need to be unique). Optional more specific information regarding the supplier could also be entered. Examples of such information include compliance statements, insurance certifications, references, OHS accreditations, standard rates and list of completed projects and such information could optionally be marked as private and not shared with others in the system unless expressly made available.

Each supplier account has a “home dashboard” which displays information relevant to that particular supplier as stored in or available to the system. Such information may be confidential or publicly available.

### (a) Search for Invitation to Tender

One option available to a supplier is to search the system for public invitations to tender which match a certain criteria. The search can be natural language based (such as “plumbing jobs in Adelaide”) or based on keywords in particular fields. Such a search will return results which can be ordered and/or classified on the basis of any number of attributes (such as location, cost, work category, etc).

### (b) Notification of an Invitation to Tender

There are two types of notifications of invitations to tender—proactive and reactive.

Proactive

In addition to relatively static attributes, other attributes such as an availability diary and default cost estimates for types of work may also be included in a supplier's profile.

For invitations which are designated as public the system will compare criteria, including optional criteria, from each supplier and proactively display those invitations which most closely match the supplier's key attributes. The supplier is then able to order and/or filter the list based on any of the included criteria.

Where selected by the supplier, the supplier may also auto accept invitations to tender and bid default amounts based on certain criteria.

Further, where selected by the supplier, the supplier may share previously private information with a customer.

Reactive

When a customer invites a specific supplier to tender for a work package the supplier is notified of the invitation via the communications module using any conventional communications method (such as email or SMS) together with a message display in the user interface module.

### (c) Responding to an Invitation to Tender

There can be three responses to an invitation to tender—Accept, Decline or Request Further Information.

Request Further Information

First, a supplier may request further information, such as more specific details to better define the requested work. In this case, the request is sent from the supplier to the customer using the system (the message is tracked in the system but may be notified to the customer using any suitable means of communication, including email, SMS or via the system user interface). Additional documents may be included in the request for further information.

The customer may respond to the request directly to the supplier via a private response or to all suppliers as an update to the invitation to tender.

Decline

The supplier may elect not to be involved in the tender. Declining the invitation optionally requests an reason from the supplier. The invitation will be marked as declined and can be viewed by the supplier in the declined group.

Accept

The supplier can accept the invitation to tender by submitting a tender proposal. The tender proposal can include a number of documents attached in support of the proposal. Each submission is optionally time stamped and digitally signed.

### Moving from the Tender Process to Contract

Once a tender has been accepted, the parties then need to migrate to a contract. Typically this involves the exchange and formal compilation of a number of documents, some of which are standard across all tenders. In this case the system can compile each document relevant to the particular tender (for example, communication, documents marked as being relevant and standard documents shared by either the customer or supplier) into a standard for contract template or completed contract.

1-52. (canceled)

53. A system for managing information comprising a data comparison module and optionally a communications module wherein the data comparison module enables refinement of information queries without the need to undertake one or more of rebuilding, re-categorizing or re-indexing the information and wherein the communications module facilitates communication between participants in the system.

54. The system according to claim 53, adapted for handling tender information and/or sharing information between a customer and a supplier.

55. The system according to claim 54, adapted to create a request for tender from a set of information; optionally wherein information relevant to a request for tender is interactively displayed to an end user.

56. The system according to claim 54, wherein the information includes potential recipients of a request for tender.

57. The system according to claim 54, wherein a potential supplier may be selected
(i) automatically from a database, or
(ii) interactively by a user.

58. The system according to claim 54, wherein information may be selectively shared between a customer and a supplier.

59. The system according to claim 54, wherein shared information may be automatically validated against a database which is optionally authoritative.

60. The system according to claim 54, wherein a tenderer may respond to a request for tender.

61. The system according to claim 54, wherein one or more documents are created from information stored or exchanged between parties in the system; optionally wherein the documents are contractual documents.

62. An information management system comprising a local data storage, a remote data storage, and a user interface for requesting information wherein
(i) one or more methodologies may be used to access the information depending on the context, or
(ii) transfer of information between the remote data storage and local data storage is proactively managed according to one or more criteria.

63. The system according to claim 62 wherein at least one copy of a document stored on the remote data storage is stored on a local data storage.

64. The system according to claim 62 wherein a document is stored in the local data storage based on one or more criteria, which may be dynamically adjusted.

65. The system according to claim 62 comprising using authentication and/or security parameters stored on the remote data storage to determine whether an end user may access particular information, such as a document.

66. The system according to claim 62 wherein the documents are proactively copied to the local data store depending on one or more parameters, which may be dynamically adjusted.

67. The system according to claim 62 comprising a communications component to communicate with another system to deliver a document to a user interface via a preferred path depending on one or more set criteria, which may be optionally dynamically adjusted.

68. A system for providing offline access to information through a standardised interface wherein offline access is enabled via a system according to claim 62.

69. An information management method comprising the steps of: receiving a request for information from a remote data storage, and
(i) analysing the context of the request and based on the analysis, selecting an information transfer methodology, or
(ii) analysing the request and proactively managing transfer of information based on one or more criteria.

70. The method according to claim 69 comprising the step of storing on a local data storage at least one copy of a document stored on the remote data storage.

71. The method according to claim 69 comprising the step of
(i) selectively storing a document in the local data storage based on one or more criteria, which may be dynamically adjusted, or
(ii) using authentication and/or security parameters stored on the remote data storage to determine whether an end user may access particular information, such as a document, or
(iii) proactively copying a document to a local data store depending on one or more parameters, which may be dynamically adjusted, or
(iv) communicating with another system to deliver a document to a user interface via a preferred path depending on one or more criteria, which may be dynamically adjusted.

72. A method for providing offline access to information through a standardized interface comprising enabling access via a method according to claim 69.
